(19) United States
(12) Patent Application Publication
(10) Pub. No.: US 2009/0051354 A1
(43) Pub. Date: Feb. 26, 2009

(54) PULSAR RING FOR MAGNETIC ENCODER

(75) Inventor: Naoto Kobayashi, Fukushima (JP)

Correspondence Address: HARNESS, DICKEY & PIERCE, P.L.C., P.O. BOX 828, BLOOMFIELD HILLS, MI, 48303, US

(73) Assignee: NOK CORPORATION, Tokyo (JP)

(21) Appl. No.: 12/192,166

(22) Filed: Aug. 15, 2008

(30) Foreign Application Priority Data
Aug. 21, 2007 (JP) 2007-214310

(51) Int. Cl. G01B 7/30

(52) U.S. Cl. 324/207.25

(57) ABSTRACT

A pulsar ring for a magnetic encoder comprises an annular holder attached to an outer periphery of a rotary side member, and a pulsar main body made of a rubber-like elastic material mixed with magnetic powder, magnetized to have multiple poles, and adhered integrally to the holder, wherein a plurality of notches are formed at predetermined intervals in a circumferential direction on a peripheral edge of the holder, and the pulsar main body is adhered to the holder so that a peripheral edge of the pulsar main body covers the peripheral edge including the notches of the holder, thereby to improve adhesive strength between the annular holder and pulsar main body.

### BACKGROUND OF THE INVENTION

1. Field of the Invention

The present invention relates to a pulsar ring for a magnetic encoder, and more particularly, relates to a pulsar ring having such a structure that multiple poles are magnetized on a molded body of a rubber-like elastic material mixed with magnetic powder.

2. Description of the Conventional Art

FIG. 3 is a sectional view taken along a plane passing through a center axis O, showing a mounted state of a conventional magnetic encoder integrated with a sealing device for sealing a bearing section in a motor vehicle wheel suspension device. In FIG. 3, reference numeral 100 indicates a sealing device mounted between an opposed end portions of an outer ring 201 and an inner ring 202 of a bearing 200 to prevent muddy water or the like from entering into the inside from the outside of the bearing.

Specifically, the sealing device 100 includes a metallic mounting ring 101 which is press-fitted to an inner peripheral surface of the outer ring 201 of the bearing 200, a thrust lip 102 and a radial lip 103 formed integrally from a rubber-like elastic material and mounted on the mounting ring 101, and a slinger 104 closely fitted to an outer peripheral surface of the inner ring 202. The front end of the thrust lip 102 is slidably in close contact with an inner side surface of a flange 104a of the slinger 104, and an inner peripheral edge of the radial lip 103 located at the inner periphery side of the thrust lip 102 is slidably in close contact with an outer peripheral surface of a sleeve 104b of the slinger 104.

A pulsar main body 105 which is formed in a disk shape from a magnetic rubber made of a rubber-like elastic material mixed with a magnetic substance and magnetized to have multiple poles at predetermined pitches in a circumferential direction, is integrally installed on an outside surface of the flange 104a of the slinger 104, and the pulsar main body 105 and the slinger 104 constitute a pulsar ring 110. More specifically, the slinger 104 functions double as a constituent element of the sealing device 100 and as a holder for integrally supporting the pulsar main body 105 of the pulsar ring 110. Further, at the outside of the pulsar ring 110, a magnetic sensor 120 is disposed in non-rotating state so as to face the pulsar ring 110, and the magnetic sensor 120 and the pulsar ring 110 constitute a magnetic encoder. The magnetic encoder generates a pulse signal with a waveform in correspondence to changes in magnetic field caused by rotation of pulsar ring 110 together with the inner ring 202 of the bearing 200, and detects the rotation.

The pulsar main body 105 is formed such that the outer peripheral portion thereof is folded back to a vicinity of the sliding contact surface with the thrust lip 102 through the outer peripheral edge of the flange 104a to secure an adhesion area with the flange 104a of the slinger 104 as the holder (For example, refer to Japanese unexamined patent publication No. 2006-162546).

However, with the structure of such kind of pulsar ring 110, there is a problem that separation of the pulsar ring 110 from the flange 104a of the slinger 104 may occur and develop at the folded back portion 105a of the outer peripheral of the pulsar main body 105 due to the impingement of muddy water, dust or the like, causing a bad influence on the precision in detecting the rotation of pulsar ring 110.

### SUMMARY OF THE INVENTION

The present invention is created in view of the above problem, and an object of the present invention is to provide a pulsar ring having an improved adhesive strength between the holder of the pulsar ring and the pulsar main body made of a rubber-like elastic material mixed with magnetic powder.

As an effective means to overcome the above-mentioned problem, the present invention provides a pulsar ring for a magnetic encoder, which comprises an annular holder attached to an outer periphery of a rotary side member, and a pulsar main body which is made of a rubber-like elastic material mixed with magnetic powder, magnetized to have multiple poles and adhered integrally to the holder, wherein a plurality of notches are formed at predetermined intervals in a circumferential direction on a peripheral edge of the holder, and the pulsar main body is adhered to the holder so that a peripheral edge of the pulsar main body covers the peripheral edge including the notches of the holder.

According to the pulsar ring for magnetic encoder of the present invention, adhesive strength between the holder and pulsar main body can be improved and lowering of precision in detecting rotation of the pulsar ring can be prevented, because adhesion area between the holder and peripheral edge of the pulsar main body is increased by the provision of a plurality of the notches formed on the peripheral edge of the pulsar main body and also an anchoring effect is generated due to the presence of the notches.

### BRIEF DESCRIPTION OF DRAWINGS

FIG. 1 is a sectional view showing a mounted state of a pulsar ring for a magnetic encoder according to a preferred embodiment of the present invention, taken along a plane passing through a center axis O.

FIG. 2 is a partially perspective sectional view showing singly the pulsar ring in FIG. 1.

FIG. 3 is a sectional view showing a mounted state of a pulsar ring for a conventional magnetic encoder, taken along a plane passing through a center axis C.

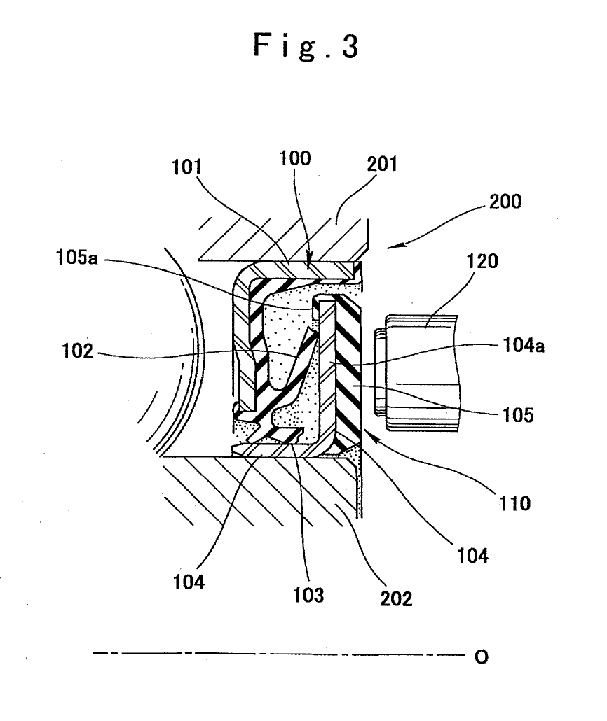

### DESCRIPTION OF PREFERRED EMBODIMENT

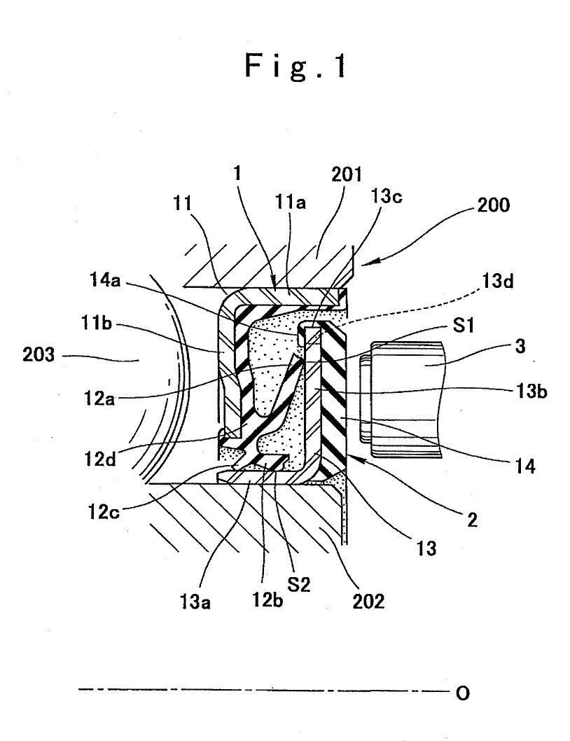

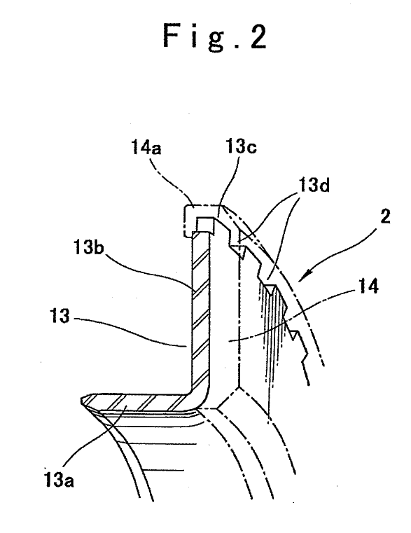

Referring now to the drawings, one embodiment of the present invention which is applied to a sealing device with a magnetic encoder for sealing a bearing section of a motor vehicle wheel suspension device will be described. FIG. 1 is a sectional view showing this embodiment in a mounted state, taken along a plane passing through a center axis O, and FIG. 2 is a partially perspective sectional view showing singly of the pulsar ring in FIG. 1.

In FIG. 1, the reference numeral 200 indicates a bearing including an outer ring 201, an inner ring 202, and a plurality of steel balls 203 disposed to roll between the outer and inner rings. Further, a sealing device 1 for sealing the bearing 200 includes a metallic mounting ring 11 installed to an inner periphery of the outer ring 201 in the bearing 200, a seal main body 12 provided integrally with the mounting ring 11, and a slinger 13 installed to an outer periphery of the inner ring 202 in the bearing 200. Here, the inner ring 202 corresponds to “a rotary side member” recited in the second paragraph of Summary of the invention.

The mounting ring 11 in the sealing device 1 is manufactured by press working or the like of a metal sheet, and the mounting ring 11 includes a cylindrical outer peripheral fitting section 11a which is press-fitted to an inner peripheral surface of the outer ring 201 in the bearing 200, and an inward flange 11b extending radially inward from the end of the outer peripheral fitting section 11a facing inside of the bearing.

The seal main body 12 in the sealing device 1 is made of a rubber-like elastic material and has a thrust lip 12a, a radial lip 12b and a grease lip 12c. The thrust lip 12a among them extends in a conical tubular shape so as to have a larger diameter at a forward end thereof from a base elastic layer 12d which is made of a rubber-like elastic material and formed on the inward flange 11b of the mounting ring 11. The radial lip 12b is located at the inner peripheral side of the thrust lip 12a and extends in a conical tubular shape so as to have a smaller diameter at a forward end thereof from an inner peripheral end of the base elastic layer 12d. The grease lip 12c extends in a conical tubular shape so as to have a smaller diameter at a forward end thereof from the inner peripheral end of the base elastic layer 12d toward the opposite side to the radial lip 12b (inside of the bearing).

The slinger 13 corresponds to a holder recited in the second paragraph of Summary of the Invention, and is manufactured by press working of a metal sheet. The slinger 13 has a sleeve 13a press-fitted to an outer peripheral surface of the inner ring 202 in the bearing 200, and a flange 13b extending radially outward from the end thereof facing outside of the bearing so as to be formed in a disk shape. The whole circumference of the forward end of the thrust lip 12a in the seal main body 12 is in slidable close contact with the inner surface of the flange 13b in the slinger 13, while the whole circumferences of the inner peripheral edges near the forward ends of the radial lip 12b and the grease lip 12c are in slidable close contact with the outer peripheral surface of the sleeve 13a in the slinger 13.

Further, a disk-shaped pulsar main body 14 is adhered integrally to the outside surface (facing outside of bearing) of the flange 13b of the slinger 13. The pulsar main body 14 is made of a magnetic rubber comprising a rubber-like elastic material mixed with fine powder of a magnetic substance such as ferrite, rare earth or the like, and magnetized to have multiple S-poles and N-poles alternately at predetermined pitches in a circumferential direction (multiple pole magnetization). The pulsar main body 14 and the slinger 13 constitute a pulsar ring 2 for magnetic encoder.

A plurality of notches 13d are formed at predetermined intervals in a circumferential direction on the outer peripheral edge 13c of the flange 13b in the slinger 13 as shown in FIG. 2, i.e. the outer peripheral edge 13c is formed in a spur gear shape with the notches 13d. The pulsar main body 14 made of a magnetic rubber is adhered to the flange 13b so that the outer peripheral edge 14a of the pulsar main body 14 covers the outer peripheral edge 13c including the notches 13d of the flange 13b.

A magnetic sensor 3 constituting a magnetic encoder together with the pulsar ring 2 is disposed in non-rotatable state at the axially outside of the pulsar ring 2 so as to face the pulsar ring 2. The magnetic sensor 3 outputs a pulse signal with a waveform in correspondence to changes in magnetic field caused by the N-poles and S-poles of the pulsar main body 14 in the pulsar ring 2 being passed alternately in the circumferential direction over the front of the magnetic sensor 3.

With the above-mentioned structure, the sealing device 1 is capable of preventing dust, muddy water or the like coming in from the outside of bearing by a throw-off action of the flange 13b due to centrifugal force at a slidably-in-close-contact portion S1 between the flange 13b in the slinger 13 rotated together with the inner ring 202 of the bearing 200 and the thrust lip 12a in the non-rotated seal main body 12. Even if a little of dust or muddy water or the like passes through the slidably-in-close-contact portion S1 to enter into the inner periphery side, it is sealed by a slidably-in-close-contact portion S2 between the sleeve 13a of the slinger 13 and the radial lip 12b, and prevented from entering into the inside of the bearing, and as a result, it is sent back to the outer periphery side of the thrust lip 12a by the throw-off action of the flange 13b due to centrifugal force. Further, the grease lip 12c prevents an outflow of grease from the inside of the bearing, and also has a function of keeping lubricity of the sliding portion between the radial lip 12b and the sleeve 13a by retaining a part of the grease at a space between the grease lip 12c and the radial lip 12b.

Further, a rotation of the pulsar ring 2 can be detected by counting the numbers of pulse signals outputted from the magnetic sensor 3, because the magnetic sensor 3 outputs pulse signal having a waveform in correspondence to changes in magnetic field caused by the N-poles and S-poles magnetized on the pulsar main body 14 being passed alternately in a rotational direction over the front of the detecting surface of the magnetic sensor 3 in accordance with the rotation of the pulsar ring 2 together with the inner ring 202. In addition, when the pulsar main body 14 is provided with such a portion that has a different magnetizing pitch (not shown) at one circumferential location, this portion can be used as a reference point for detecting a specific position.

Furthermore, when a motor vehicle is running, the pulsar ring 2 is placed in a severe environment where dirt or muddy water comes from the road surface. However, since the outer peripheral edge 13c of the flange 13b of the slinger 13 is formed in a spur gear shape with a plurality of notches 13d and the pulsar main body 14 is adhered to the flange 13b so that the outer peripheral edge 14a of the pulsar main body 14 made of a magnetic rubber covers the outer peripheral edge 13c including the notches 13d of the flange 13b to provide larger adhesion area, and the notches 13d also provide an anchoring effect to the outer peripheral edge 14a of the pulsar main body 14, thus the outer peripheral edge 14a of the pulsar main body 14 cannot easily be separated from the slinger 13 by collision or the like of dirt or muddy water, and it is possible to prevent effectively lowering of precision in detecting rotation of pulsar ring 2 which may be caused by the progress of separation.

Further, it is preferable to form the notches 13d at least four circumferential locations on the outer peripheral edge 13c of the flange 13b of the slinger 13. A shape of the notches 13d is optional. Furthermore, for example, when the magnetizing pitch in the pulsar main body 14 is made to correspond to a pitch between notches 13d formed on the outer peripheral edge 13c of the flange 13b of the slinger 13 or to an integral multiple of the pitch, it is possible to prevent lowering of precision in detecting the rotation due to the formation of the notches 13d.

Furthermore, the above embodiment shown in FIGS. 1 and 2 is an example where the present invention is applied to a sealing device with a magnetic encoder for sealing a bearing section of a motor vehicle wheel suspension device, however, the present invention may be applied to a device that the pulsar ring 2 is provided separately from the sealing device 1.

What is claimed is:

1. A pulsar ring for a magnetic encoder comprising an annular holder attached to an outer periphery of a rotary side member, and a pulsar main body made of a rubber-like elastic material mixed with magnetic powder, magnetized to have multiple poles, and adhered integrally to the holder, wherein a plurality of notches are formed at predetermined intervals in a circumferential direction on a peripheral edge of the holder, and the pulsar main body is adhered to the holder so that a peripheral edge of the pulsar main body covers the peripheral edge including the notches of the holder.
